(19) United States
(12) Patent Application Publication
(10) Pub. No.: US 2008/0309262 A1
(43) Pub. Date: Dec. 18, 2008

(54) Multiple Phase Electric Motor and Drive

(76) Inventors: Jean-Marc Cyr, Candiac (CA); Ruisheng Shi, Montreal (CA)

Correspondence Address: FAY KAPLUN & MARCIN, LLP, 150 BROADWAY, SUITE 702, NEW YORK, NY, 10038, US

(21) Appl. No.: 12/125,309

(22) Filed: May 22, 2008

Related U.S. Application Data
(60) Provisional application No. 60/924,615, filed on May 23, 2007.

(51) Int. Cl. H02P 27/06

(52) U.S. Cl. 318/139

(57) ABSTRACT

A multiple phase electric motor provided with multiple inverter power circuits is described herein. The capacity of the capacitor bank required for multiple phase motors operating from a DC power source is therefore decreased. This is done by forming groups of phases that are powered by a separate inverter power circuit. The inverter power circuits are connected to the same DC power source including a bank of capacitors and are so controlled as to be phase offset from one another to allow the use of a smaller capacity capacitor bank.

### PRIORITY CLAIM

This application claims the benefit of U.S. Provisional Patent Application Ser. No. 60/924,615 filed on May 23, 2007, the specification of which is expressly incorporated herein, in its entirety, by reference.

### FIELD

The present invention relates to electric motors and drives for electric motors. More specifically, the present invention is concerned with multiple phases electric motors provided with grouped phases linked to distinct converters.

### BACKGROUND

Multi-phase electric motors are well known in the art. Often, they are operated from direct current (DC) power, for example from batteries, via an inverter power circuit that controls the flow of current in the various phases. In those cases, a capacitor bank is conventionally used between the DC source and the inverter power circuit.

For medium to large power motors, the capacity, size and cost of the capacitor bank is generally high, which is a drawback.

### BRIEF DESCRIPTION OF THE DRAWINGS

In the appended drawings:

FIG. 1 is a block diagram of a nine-phase electric motor and drive circuit where the phases are grouped three by three and where each group is connected to a distinct inverter power circuit;

FIG. 2 is a more detailed block diagram of the motor of FIG. 1;

FIG. 3 is a schematic view of the internal stator and the external rotor of the motor of FIG. 1; and

FIG. 4 is a graph illustrating the current in the capacitor bank for one, two and three three-phase systems.

### DETAILED DESCRIPTION

In accordance with an illustrative embodiment of the present invention, there is provided a drive circuit for a multiple phase electric motor comprising coils grouped in at least two groups of at least two phases each and a DC power source including a battery and a bank of capacitors; the drive circuit comprising:

at least two inverter circuits each associated with a respective group of at least two phases; the inverter circuits being powered by the DC power source;

a controller so connected to the at least two inverter circuits as to independently control the at least two inverter circuits so that a phase difference exists between the at least two inverter circuits.

In accordance with another aspect of the present invention, there is provided a multiple phase electric motor powered by a DC power source including a battery and a bank of capacitors; the multiple phase electric motor comprising:

a stator including a plurality of coils defining phases; the coils being grouped into at least two groups of at least two phases;

a rotor coaxial with the stator;

a drive circuit including:

at least two inverter circuits each associated with a respective group of at least two phases; the inverter circuits being powered by the DC power source;

a controller so connected to the at least two inverter circuits as to independently control the at least two inverter circuits so that a phase difference exists between the at least two inverter circuits.

In accordance with another aspect of the present invention, there is provided a multiple phase electric motor system comprising:

a DC power source including a battery and a bank of capacitors;

a stator including a plurality of coils defining phases; the coils being grouped into at least two groups of at least two phases;

a rotor coaxial with the stator; and

a drive circuit including:

at least two inverter circuits each associated with a respective group of at least two phases; the inverter circuits being so connected to the DC power source as to be powered thereby;

a controller so connected to the at least two inverter circuits as to independently control the at least two inverter circuits so that a phase difference exists between the at least two inverter circuits.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

Other objects, advantages and features of the present invention will become more apparent upon reading of the following non-restrictive description of illustrative embodiments thereof, given by way of example only with reference to the accompanying drawings.

Generally stated, embodiments of the present invention aim at decreasing the capacity of the capacitor bank required for multiple phase motors operating from a DC power source. This is done by forming groups of phases that are powered by a separate inverter power circuit. The inverter power circuits are connected to the same DC power source including a bank of capacitors and are so controlled as to be phase offset from one another to allow the use of a smaller capacity capacitor bank.

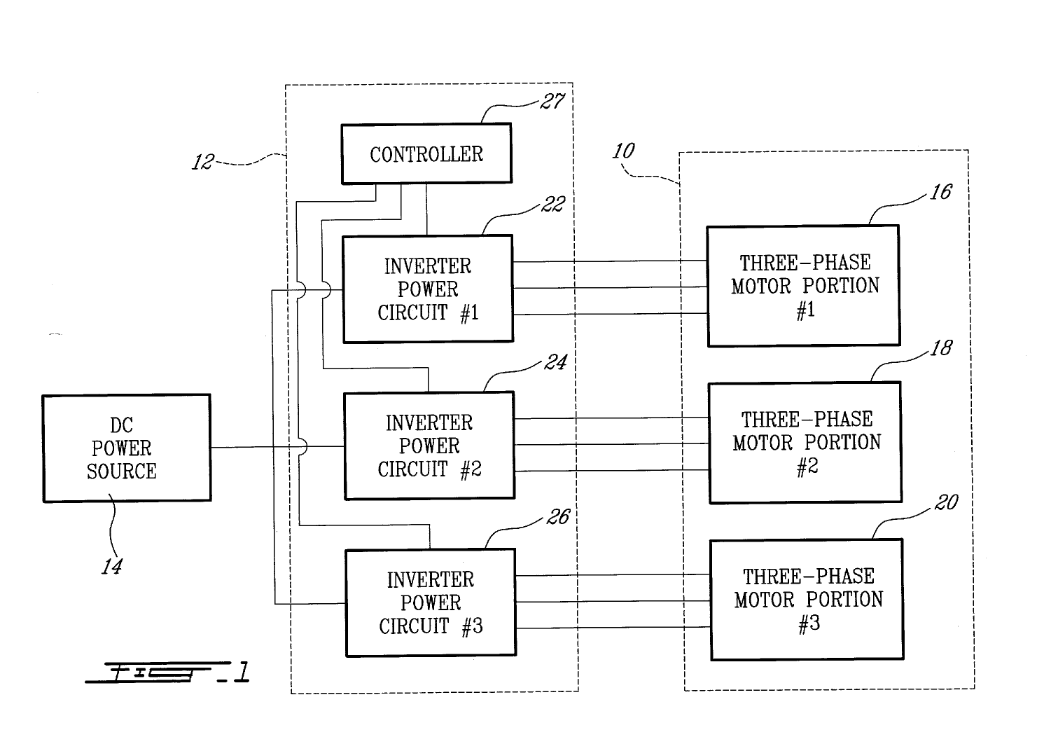

FIG. 1 of the appended drawings schematically show, in a block diagram, a nine-phase electric motor 10 with its drive circuit 12 and DC power source 14. The nine phases of the electric motor 10 are divided in three three-phase portions 16, 18 and 20 each associated with a respective separate inverter power circuit 22, 24 and 26. The three inverter power circuits 22, 24 and 26 are connected to the common DC power source 14. It is to be noted that the drive circuit 12 also includes a controller 27 is used to control the inverter power circuits 22-26 as will be described hereinbelow.

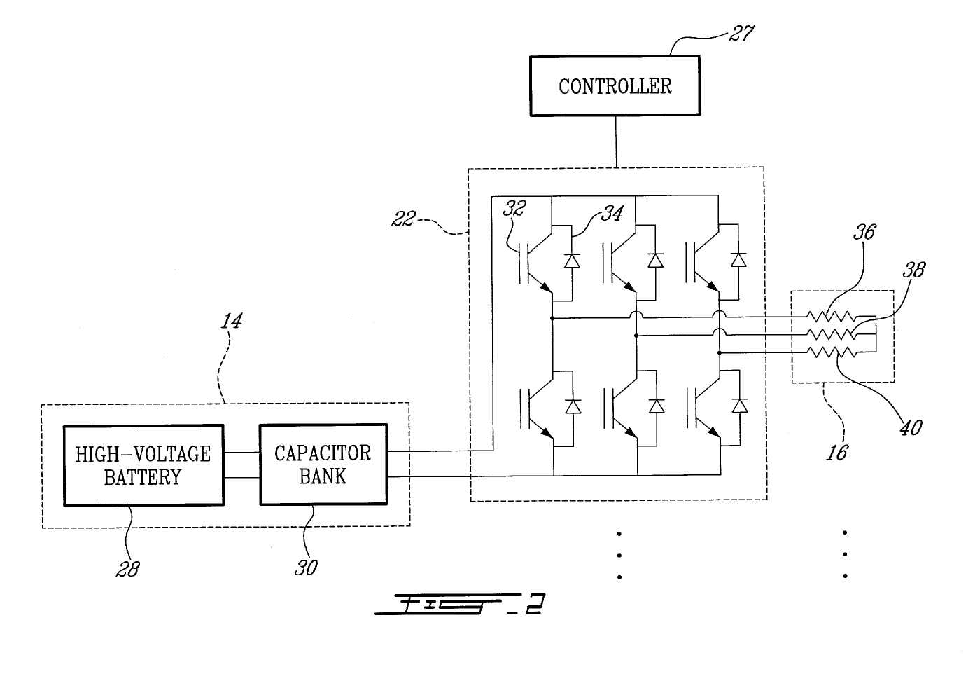

Turning now to FIG. 2, the DC power source 14 includes a high voltage battery 28 and a capacitor bank 30. Since the three inverter power circuits 22, 24 and 26 are identical and since the three-phase motor portions 16, 18 and 20 are identical, only one of each is illustrated in FIG. 2 and will be described hereinbelow.

The schematically illustrated three-phase inverter power circuit 22 conventionally includes six transistors 32 and six diodes 34. Such an inverter power circuit 22 is believed well known in the art. Accordingly, its operation to control the current supplied to its associated three-phase motor portion 16 will not be further described herein. However, it is to be noted that the transistors 32 may be controlled by the controller 27 so as to precisely adjust the phase of the power circuits 22 to 26 with respect to one another.

The three-phase motor portion 16 includes three phases 36, 38 and 40 each including at least one coil mounted to the stator of the machine.

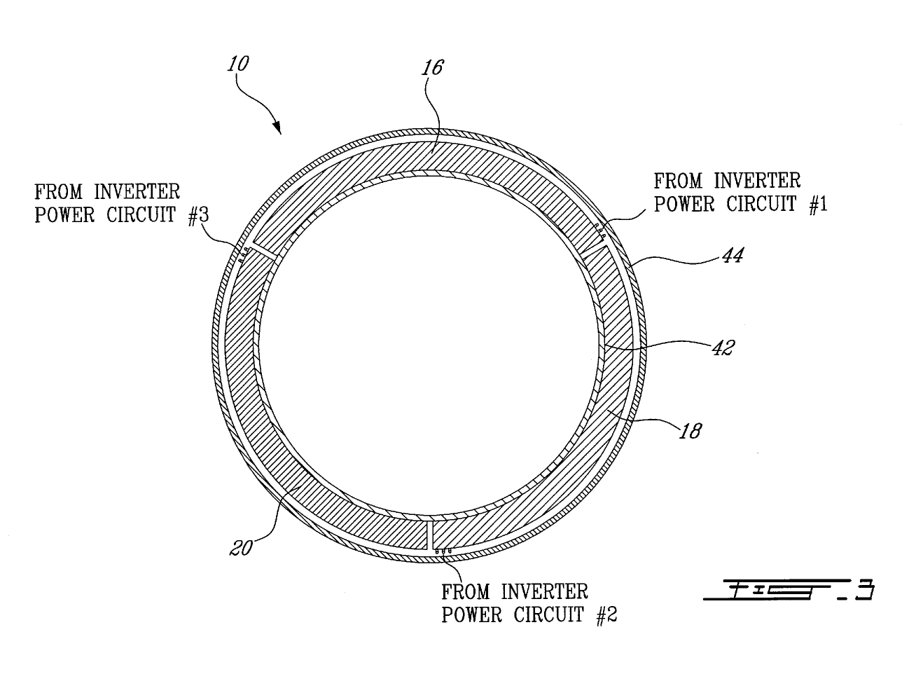

Turning now to FIG. 3 of the appended drawings, the schematic mechanical configuration of the motor 10 will be briefly described. The motor 10 includes an internal stator 42 and an external rotor 44. The internal stator 42 is provided with the three three-phase motor portions 16, 18 and 20 that each covers about 120 degrees of the circumference of the stator 42. The external rotor 44 is provided, in this case, with permanent magnets (not shown).

It is to be noted that instead of separating the three three-phase motor portions as illustrated in FIG. 3, it would be possible to allow each of the nine phases to span the entire circumference of the stator 42. However, this would create coupling between the phases. This coupling would generally mean that higher current would be required in the phases.

To allow for the reduction of the capacity of the capacitor bank 30, the three inverter power circuits 22-26 are operated at switching frequencies that are out of phase by 120 degrees from one another. This can easily be controlled by the controller 27.

It has been found that by controlling the inverter power circuits 22-26 in such a way, the capacity of the capacitor bank 30 can be about the same as would be required if only one inverter power circuit was present, yielding a reduction in the capacity of the capacitor bank of about 66%.

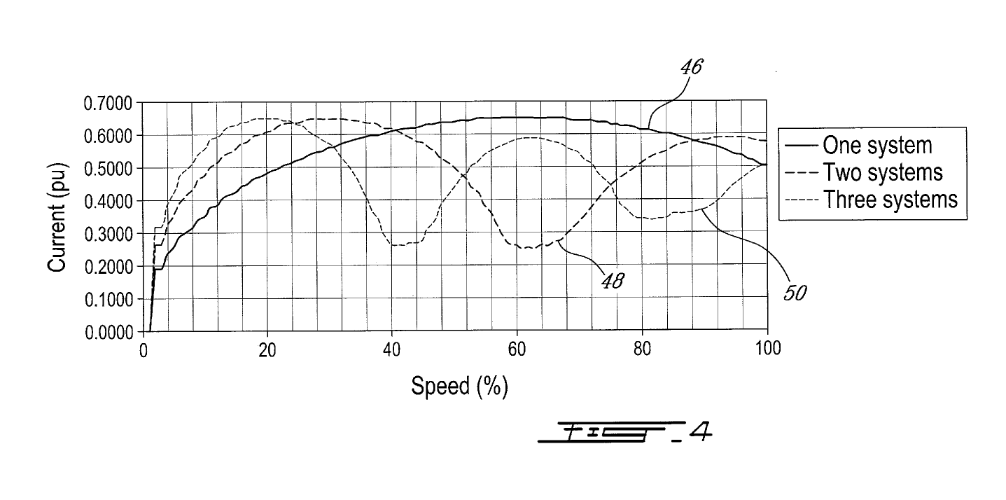

FIG. 4 of the appended drawings illustrates the current in the capacitors versus the rotational speed of the motor when one, two and three three-phase systems (motor portion and inverter power circuits) are used.

It is to be noted that the values of FIG. 4 are highly dependent on the topology of the motor and inverters used. They are therefore only illustrative. The amplitudes of the currents are related to the RMS phase currents.

When one system is used (see line 46) the current in the capacitor reaches a maximal value when the rotational speed reaches about 60% of the maximal speed of the motor. Further increase in the rotational speed cause a decrease of the current in the capacitor. This is believed to be due to the fact that the duty cycle of the transistors controlling the various phases of the motor increases as the speed increases. Above a certain duty cycle of the transistors, the proportion of the DC current transferred directly to the phases of the motor portions without transiting via the capacitor bank with respect to the current supplied to the capacitor bank by the battery becomes such that the overall current in the capacitor decreases.

When two systems are used (see line 48), the switching frequency of the second system is out of phase by 180 degrees with respect to the switching frequency of the first system. It is apparent from FIG. 4 that the current in the capacitor reaches a maximal value when the rotational speed reaches about 30% of the maximal speed of the motor, i.e. at half the speed required when only one system is used. The current in the capacitor then decreases for further speed increases and never gets as high as when the rotational speed reaches about 30% of the maximal speed.

The same is true when three systems are used (see line 50). The switching frequency of the second system is out of phase by 120 degrees with respect to the switching frequency of the first system and the switching frequency of the third system is out of phase by 120 degrees with respect to the switching frequency of the second system. In this case, the current in the capacitor reaches a maximal value when the rotational speed reaches about 20% of the maximal speed of the motor, i.e. at a third of the speed required when only one system is used.

It is to be noted that the current in the capacitor bank reaches a low point and then starts increasing again, without reaching the maximal value. This is due to the meshing of the various phase currents of the motor portions.

It is to be noted that while the embodiments described herein and illustrated in the appended drawings have three groups of three-phases each, the number of groups and the number of phases could be modified according to the application without departing from the spirit and nature of the present invention.

It is also to be noted that while the three-phase motor portions are illustrated herein in a star configuration, a delta configuration could also be used without departing from the spirit and nature of the present invention.

One skilled in the art will understand that while an internal stator/external rotor electric motor was described hereinabove, the present invention is not limited to this motor configuration and that a more conventional external stator configuration could be used. Furthermore, while the electric motor described hereinabove is a permanent magnet motor, other motor technologies could be used.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention as defined in the appended claims.

What is claimed is:

1. A drive circuit for a multiple phase electric motor comprising coils grouped in at least two groups of at least two phases each and a DC power source including a battery and a bank of capacitors; the drive circuit comprising:
at least two inverter circuits each associated with a respective group of at least two phases; the inverter circuits being powered by the DC power source; and
a controller so connected to the at least two inverter circuits as to independently control the at least two inverter circuits so that a phase difference exists between the at least two inverter circuits.

2. The drive circuit recited in claim 1, wherein the multiple phase electric motor includes three groups of three phases and wherein the at least two inverter circuits include three inverter circuits.

3. The drive circuit recited in claim 2, wherein the controller controls the phase difference between the three inverter circuits so that a 120 degree phase difference exists between the three inverter circuits.

4. A multiple phase electric motor powered by a DC power source including a battery and a bank of capacitors; the multiple phase electric motor comprising:
a stator including a plurality of coils defining phases; the coils being grouped into at least two groups of at least two phases;
a rotor coaxial with the stator;
a drive circuit including:
at least two inverter circuits each associated with a respective group of at least two phases; the inverter circuits being powered by the DC power source;
a controller so connected to the at least two inverter circuits as to independently control the at least two inverter circuits so that a phase difference exists between the at least two inverter circuits.

5. The multiple phase electric motor recited in claim 4, wherein the multiple phase electric motor includes three groups of three phases and wherein the at least two inverter circuits include three inverter circuits.

6. The multiple phase electric motor recited in claim 5, wherein the controller controls the phase difference between the three inverter circuits so that a 120 degree phase difference exists between the three inverter circuits.

7. The multiple phase electric motor recited in claim 5, wherein each of the three groups of three phases are so mounted to the stator as to each covers about 120 degrees of the circumference of the stator.

8. The multiple phase electric motor recited in claim 4, wherein the rotor is externally mounted to the stator.

9. A multiple phase electric motor system, comprising:
a DC power source including a battery and a bank of capacitors;
a stator including a plurality of coils defining phases; the coils being grouped into at least two groups of at least two phases;
a rotor coaxial with the stator;
a drive circuit including:
at least two inverter circuits each associated with a respective group of at least two phases; the inverter circuits being so connected to the DC power source as to be powered thereby;
a controller so connected to the at least two inverter circuits as to independently control the at least two inverter circuits so that a phase difference exists between the at least two inverter circuits.

10. The multiple phase electric motor recited in claim 9, wherein the multiple phase electric motor includes three groups of three phases and wherein the at least two inverter circuits include three inverter circuits.

11. The multiple phase electric motor recited in claim 10, wherein the controller controls the phase difference between the three inverter circuits so that a 120 degree phase difference exists between the three inverter circuits.

12. The multiple phase electric motor recited in claim 10, wherein each of the three groups of three phases are so mounted to the stator as to each covers about 120 degrees of the circumference of the stator.

13. The multiple phase electric motor recited in claim 9, wherein the rotor is externally mounted to the stator.
